(19) United States
(12) Patent Application Publication
(10) Pub. No.: US 2010/0211521 A1
(43) Pub. Date: Aug. 19, 2010

(54) COMPUTERIZED SYSTEM AND METHOD OF CREATING AND DEVELOPING EXCHANGE TRADED FUNDS

(76) Inventor: Mark Shemtob, Denville, NJ (US)

Correspondence Address: MICHAEL RIES, 318 PARKER PLACE, OSWEGO, IL, 60543, US

(21) Appl. No.: 12/707,581

(22) Filed: Feb. 17, 2010

Related U.S. Application Data
(60) Provisional application No. 61/208,015, filed on Feb. 19, 2009.
(60) Provisional application No. 61/208,688, filed on Feb. 26, 2009.

(51) Int. Cl. G06Q 40/00

(52) U.S. Cl. 705/36 R; 705/37

(57) ABSTRACT

The present invention is a computerized system and method for calculating an optimum allocation for exchanged traded funds (ETFs) that include risk structured exchanged traded funds (ETFs) and distribution structured exchanged traded funds (ETFs). The system includes one or more input devices to input ETF data, one or more output devices to output processed ETF data, a processor for processing ETT data, a memory for storing ETF data on a storage medium and software to work in combination with the input devices, the output devices, the processor and the memory for receiving, processing and storing computer program steps for program control and manipulation of the ETF data in the system. There is also a computerized software method for calculating an optimum allocation of investments for risk structured exchanged traded funds ETFs as well as a separate computerized software method for calculating an optimum allocation of investments for distribution structured ETFs.

This application claims priority to U.S. Provisional Application 61/208,015 filed on Feb. 19, 2009 and U.S. Provisional Application 61/208,688 filed on Feb. 26, 2009, the entire disclosures of which are incorporated by reference.

### TECHNICAL FIELD & BACKGROUND

The present invention generally relates to a computerized system and method of creating and developing exchange traded funds (ETFs). More specifically, the invention is a computerized system and method of creating and developing distribution structured ETFs and risk structured ETFs.

It is an object of the invention to provide a computerized system and method which tracks a collection of related securities to a stock market index which can be traded like an individual stock, while having the diversification of an investment like a mutual fund.

It is also an object of the invention to provide a computerized system and method that trades like a stock, is diversified, but is also structured to seek a specific return over a specific period of time while having a distribution or liquidation assumption pattern.

What investors really need is a computerized system and investment method for an investment vehicle that trades like a stock, is diversified and indexed, but is also structured to seek a specific return over a specific period of time while having a distribution or liquidation assumption pattern.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates the overall system architecture of the computerized system and method, in accordance with one embodiment of the present invention.

FIG. 2A illustrates the software steps performed by the computerized system and method to achieve an optimum allocation from input data for a risk structured ETF, in accordance with one embodiment of the present invention.

FIG. 2B illustrates the software steps performed by the computerized system and method to achieve an optimum allocation from input data for a distribution structured ETF, in accordance with one embodiment of the present invention.

FIG. 3A illustrates a matrix for a risk structured ETF portfolio standard deviation in percent, in accordance with one embodiment of the present invention.

FIG. 3B illustrates a matrix for a distribution structured ETF portfolio standard deviation in percent, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

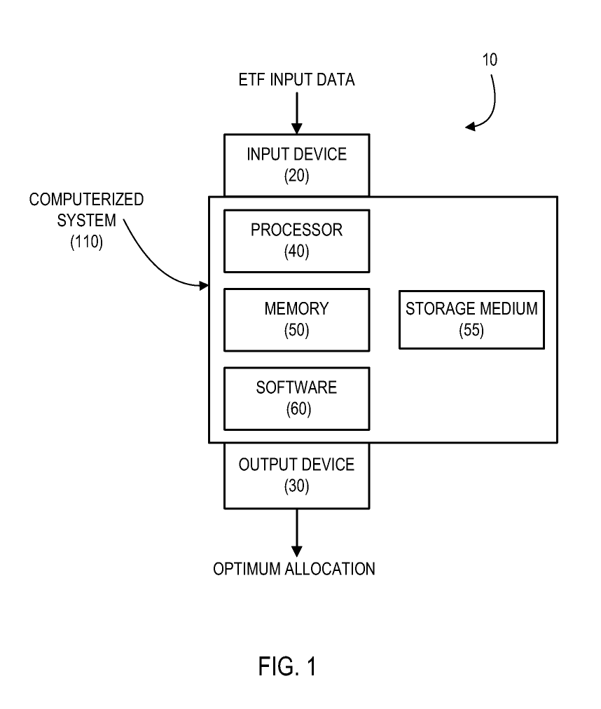

FIG. 1 illustrates one embodiment of an overall system architecture of the computerized system for calculating an optimum allocation for exchanged traded funds (ETFs) 10. The present invention generally relates to a computerized system for calculating an optimum allocation for exchanged traded funds (ETFs) 10, as it is described in this application. ETFs will include risk structured exchanged traded funds and distribution structured exchanged traded funds, along with risk structured ETF data and distribution structured ETF data. Also in this application, ETFs will be referred to as total ETFs and ETF data will be referred to as total ETF data.

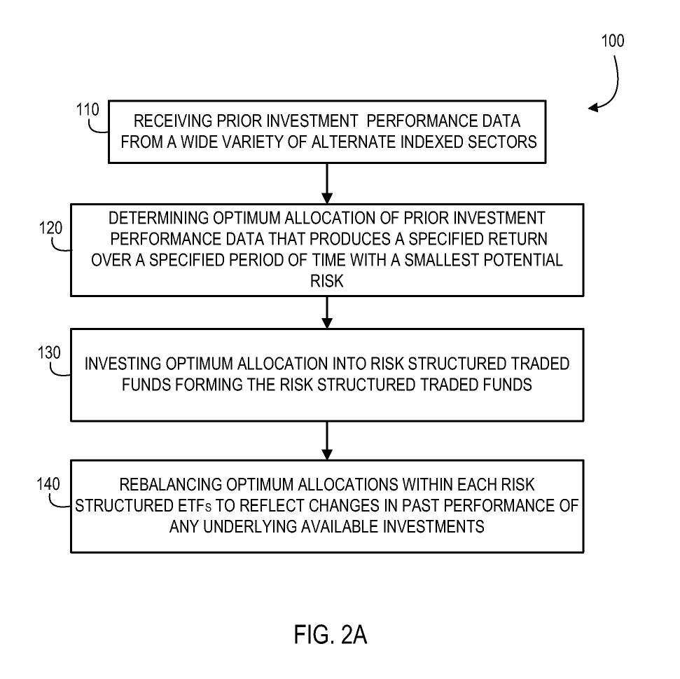

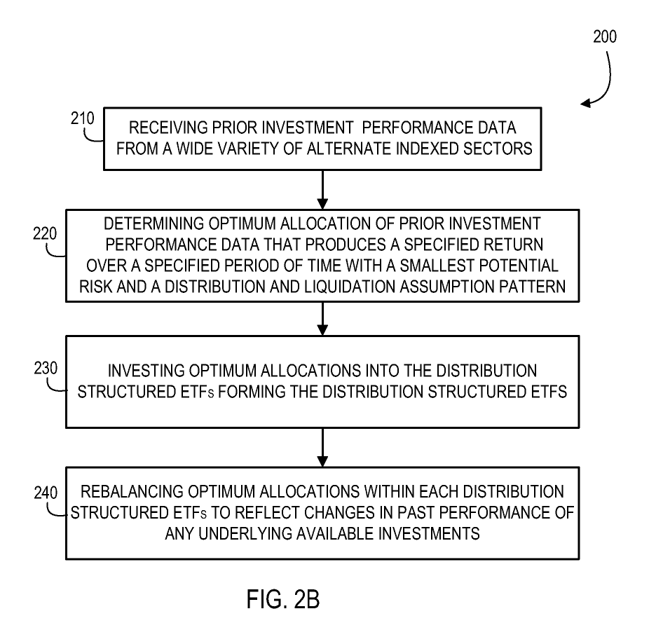

The computerized system 10 includes one or more input devices 20 to input the total ETF data, one or more output devices 30 to output the processed total ETF data, a processor 40 for processing the total ETF data, a memory 50 for storing the total ETF data on a storage medium 55 (not shown) and software 60 to work in combination with the input devices 20, the output devices 30, the processor 40, the memory 50, the storage medium 55 for receiving, processing and storing computer program steps for program control and manipulation of the total ETF data involving the computerized system 10. The input devices 20 will input total ETF input data that is discussed in greater detail in FIG. 2a and FIG. 2b, which discuss the software steps performed by the computerized system 10 to achieve an optimum allocation from input data for a risk structured ETF and the software steps performed by the computerized system 10 to achieve an optimum allocation from input data for a distribution structured ETF. The computerized system 10 typically uses a keyboard, another computer, a cell phone or a personal digital device (all not shown) for an input device 20, a computer monitor and or printer (not shown) for an output device 30, a central processing unit (not shown) for a processor 40 and a hard drive, a floppy disc, a CD ROM disc or a thumb drive (all not shown) for a memory 50 and a storage medium 55. The computerized system 10 however, is not limited to these features and peripherals, all of which are well-known to one schooled in the art.

FIG. 2A illustrates the software steps performed by one embodiment of the computerized system 10 to achieve an optimum allocation of investments from input data for a risk structured ETF. This is a computerized software method for calculating an optimum allocation of investments for risk structured exchanged traded funds (ETFs) 100 that involves receiving prior investment performance data from a wide variety of alternate indexed sectors 110, determining the optimum allocation of the prior investment performance data that produces a specified return over a specified period of time with the smallest potential risk 120, investing the optimum allocation into the risk structured exchanged traded funds thereby forming the risk structured exchanged traded funds 130 and rebalancing the optimum allocation within each risk structured ETF to reflect changes in past performance of any underlying available investments 140.

The first step of the method for an optimum allocation for a risk structured ETF 100 involving receiving prior investment performance data from a wide variety of alternate indexed sectors 110 involves getting prior investment performance data from indexed sectors from the S & P 500 Index, the Lehman Brothers Total Return Index, commodities indexes and foreign stock exchange indexes. Risk structured ETFs are also not limited to these types of indexes as any indexed sector can be used with a risk structured ETF. Risks structured ETFs are mostly used by individuals and institutions as a way to cost efficiently invest in a wide variety of market sectors in a single investment security that trades like stock. Risk structured ETFs are structured with a goal of accumulating and increasing assets and not distributing assets, which is sometimes is a requirement of some investors which can be better done with a distribution structured ETF, as discussed in FIG. 2B.

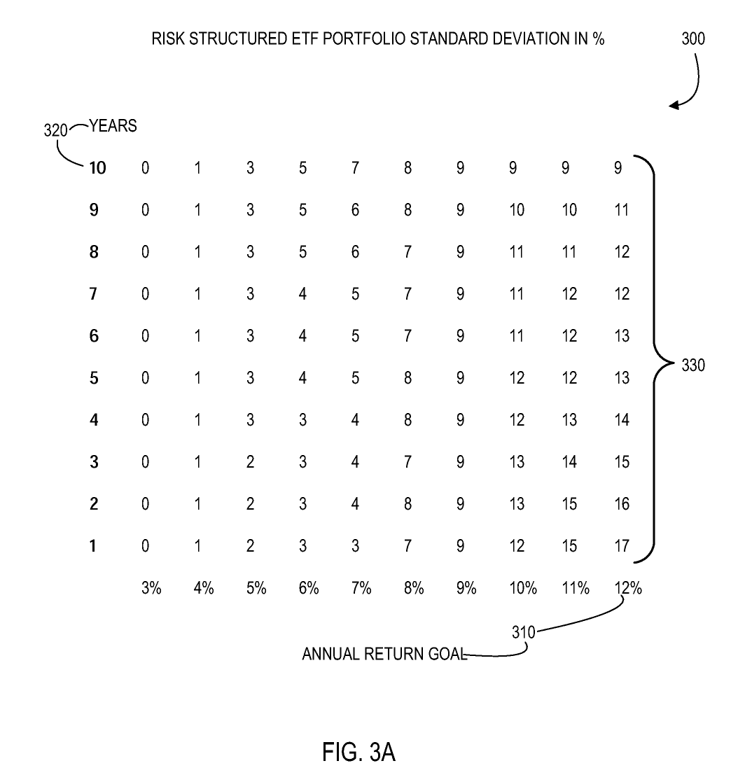

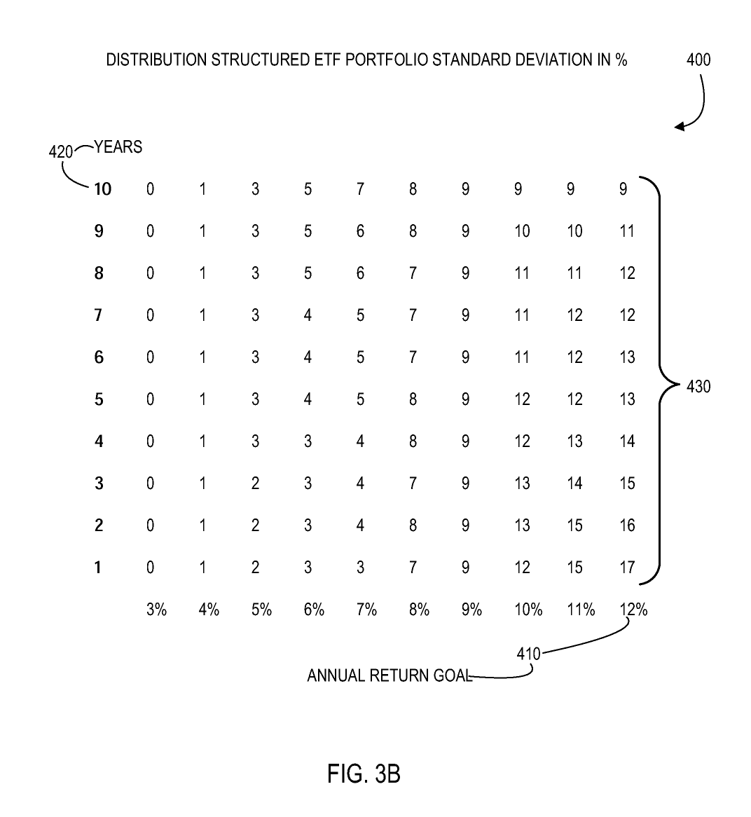

The second step of the method for an optimum allocation for a risk structured ETF 100 is determining the optimum allocation of the prior investment performance data that produces a specified return over a specified period of time with the smallest potential risk 120. It has been demonstrated that investing goals can best be achieved through a diversified portfolio as opposed to investing in one, two or a few sectors. By combining investments from multiple sectors in an investment portfolio, the potential risk associated with dramatic losses can be reduced significantly. This is achieved as a result of the fact that alternative investment types are often only slightly or negatively correlated and thus achieve different investment returns in the same period. As a result many investment organizations offer to investors mutual funds that are diversified through a combination of investments. These funds are usually described as growth, moderate or conservative depending on the relative allocation of equity and fixed income investments, but do not trade like stocks and are not designed to achieve specific investment returns over specific investment durations. The smallest potential risk for an optimum allocation for a risk structured ETF is measured by standard deviation percentage, as discussed further in FIG. 3A.

The third step of the method for an optimum allocation for a risk structured ETF 100 involves investing the optimum allocation into the risk structured exchanged traded funds, thereby forming the risk structured exchanged traded funds 130. This occurs once the optimum allocation for a risk structured ETF is established and the computerized system 10 simply makes the investments through traditional investment purchasing channels, involved with the calculated optimum allocation. The computerized system 10 will develop an array of risk structured ETFs that will be constructed for various time versus investment return combinations that are based on the optimum allocation of the prior investment performance data and the previously mentioned smallest potential of risk. These ETFs will be made up of a portfolio of indexed investments derived from a wide variety of alternate sectors. This then leads into the fourth step of the method for an optimum allocation for a risk structured ETF 100 that involves rebalancing at alternative time intervals the optimum allocation within each said risk structured ETFs to reflect changes in past performance of any underlying available investments 140 to maximize the computerized system's 10 results. Rebalancing can be performed based on differing time horizons ranging from daily to annually or even longer.

FIG. 2B illustrates the software steps performed by one embodiment of the computerized system 10 to achieve an optimum allocation from input data for a distribution structured ETF. This is a computerized software method for calculating an optimum allocation of investments for distribution structured exchanged traded funds (ETFs) 200 that involves receiving prior investment performance data from a wide variety of alternate indexed sectors 210, determining the optimum allocation of the prior investment performance data that produces a specified return over a specified period of time with a smallest potential risk 220, investing the optimum allocation into the distribution structured exchanged traded funds, thereby forming the distribution structured exchanged traded funds 230 and rebalancing at alternative time intervals the optimum allocation within each distribution structured ETF to reflect changes in past performance of any underlying available investments 240. Rebalancing can be performed based on differing time horizons ranging from daily to annually or even longer.

The important difference between the computerized software method for calculating an optimum allocation of investments for distribution structured exchanged traded funds (ETFs) 200 and the computerized software method for calculating an optimum allocation of investments for risk structured exchanged traded funds (ETFs) 100 is that the computerized software method for calculating an optimum allocation of investments for distribution structured exchanged traded funds (ETFs) 200 is designed for investors who desire distributing, liquidating or withdrawing assets from their respective distribution structured ETFs. This would include retirees, who have accumulated substantial assets in their ETFs and want to withdraw them to live off of while retiring. Other investors may want to distribute, liquidate or withdraw assets from their distribution structured ETFs for college funds, emergencies or other reasons.

The computerized software method for calculating an optimum allocation of investments for distribution structured exchanged traded funds (ETFs) 200 and the computerized software method for calculating an optimum allocation of investments for risk structured exchanged traded funds (ETFs) 100 are very similar in that they each share the flexibility advantages of trading like a stock, but are diversified for minimal risk, while also achieving specific returns over specific time durations. The steps of the computerized software method for calculating an optimum allocation of investments for distribution structured exchanged traded funds (ETFs) 200 and the computerized software method for calculating an optimum allocation of investments for risk structured exchanged traded funds (ETFs) 100 are the same except that in determining the optimum allocation, the distribution structured ETFs must take into account a distribution assumption pattern for investor liquidity. Such distribution assumption patterns could entail a level, increasing, or decreasing amount over a period of time ranging from one year or more. Otherwise, the two methods are the same, except that one deals with risk structured ETFs of course, and the other deals with distribution structured ETFs.

These similarities are reflected in FIGS. 3A and 3B, which indicate a matrix of both risk structured ETF portfolio standard deviation in percentage 300 in FIG. 3A and distribution structured ETF portfolio standard deviation in percentage 400 in FIG. 3B. Both matrixes are based on the relationship of annual return goals 310,410 versus time in years 320,420 and the effect on risk structured ETF portfolio standard deviation in percent and distribution structured ETF portfolio standard deviation in percent. The actual data in each of the matrixes 330,430 shown in FIGS. 3A and 3B is arbitrary and will be unique for each individual risk structured ETF and distribution structured ETF. These matrixes 330,430 are one of the important byproducts of the computerized system for calculating an optimum allocation for a total ETF 10, which reflect the diversified and flexible characteristics of the risk structured ETF and distribution structured ETF.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A computerized system for calculating an optimum allocation for exchanged traded funds (ETFs) that include risk structured exchanged traded funds (ETFs) and distribution structured exchanged traded funds (ETFs), risk structured ETF data, distribution structured ETF data and total ETF data that includes said risk structured ETF data and distribution structured ETF data, comprising:
one or more input devices to input said total ETF data;
one or more output devices to output processed said total ETF data;
a processor for processing said total ETF data;
a memory for storing said total ETF data on a storage medium;
software to work in combination with said input devices, said output devices, said processor and said memory for receiving, processing and storing computer program steps for program control and manipulation of said total ETF data in said system.

2. The system according to claim 1, wherein said input device is a keyboard.

3. The system according to claim 1, wherein said input device is another computer.

4. The system according to claim 1, wherein said input device is a cell phone.

5. The system according to claim 1, wherein said input device is a personal digital device.

6. The system according to claim 1, wherein said output device is a computer monitor.

7. The system according to claim 1, wherein said output device is a printer.

8. The system according to claim 1, wherein said processor is a central processing unit.

9. The system according to claim 1, wherein said storage medium is a hard drive.

10. The system according to claim 1, wherein said storage medium is a floppy disc.

11. The system according to claim 1, wherein said storage medium is a CD ROM disc.

12. The system according to claim 1, wherein said storage medium is a thumb drive.

13. A computerized software method for calculating an optimum allocation of investments for risk structured exchanged traded funds (ETFs), comprising:
receiving prior investment performance data from a wide variety of alternate indexed sectors;
determining said optimum allocation of said prior investment performance data that produces a specified return over a specified period of time with a smallest potential risk;
investing said optimum allocation into said risk structured exchanged traded funds thereby forming said risk structured exchanged traded funds;
rebalancing over a variety of time horizons said optimum allocation within each said risk structured ETF to reflect changes in past performance of any underlying available investments.

14. The method according to claim 13, wherein said prior investment performance data is from the S & P 500 Index, the Lehman Brothers Total Return Index, commodities indexes and foreign stock exchange indexes.

15. The method according to claim 13, wherein said smallest potential risk is measured by a standard deviation percentage.

16. The method according to claim 13, wherein an array of said risk structured ETFs will be constructed for various time versus investment return combinations based on said prior investment performance data may be on a level, increasing, or decreasing basis over a period of time ranging from one year or more.

17. A computerized software method for calculating an optimum allocation of investments for distribution structured exchanged traded funds (ETFs), comprising:
receiving prior investment data from a wide variety of alternate indexed sectors;
determining said optimum allocation of said indexed investment data that produces a specified return over a specified period of time with a smallest potential risk and a distribution and liquidation assumption pattern;
investing said optimum allocation into said distribution structured exchanged traded funds thereby forming said distribution structured exchanged traded funds;
rebalancing over a variety of time horizons said optimum allocations within each said distribution structured ETFs to reflect changes in past performance of any underlying available investments.

18. The method according to claim 17, wherein said prior indexed investment data is from the S & P 500 Index, Lehman Brothers Total Return Index, commodities indexes and foreign stock exchange indexes.

19. The method according to claim 17, wherein said smallest potential risk is measured by a standard deviation percentage.

20. The method according to claim 17, wherein an array of said distribution structured ETFs will be constructed for various time versus investment return combinations based on said prior investment performance data and may be on a level, increasing, or decreasing basis over a period of time ranging from one year or more
